(19) United States
(12) Patent Application Publication
(10) Pub. No.: US 2005/0028440 A1
(43) Pub. Date: Feb. 10, 2005

(54) Plants growing device

(76) Inventor: Wen-Tsan Ko, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/632,898

(22) Filed: Aug. 4, 2003

(51) Int. Cl. A01C 1/04

(52) U.S. Cl. 47/56

(57) ABSTRACT

A plant growing device includes a seed fixing film with an upper thin film thereon. One or more plant seeds are disposed on the seed fixing film and covered with the thin film or gel. The device can be banded as a reel or be folded as in computer form paper for saving space.

### 1. FIELD OF THE INVENTION

The invention relates to a plants growing device, and in particular, to a plants growing device for contenting various requirement of different consumer and promoting agriculture.

### 2. DESCRIPTION OF THE PRIOR ART

Conventional growing manner of plants or vegetables such as loosing earth, seeding, fertilizing, disinfecting, harvesting or the like, also with routine watering and weeding to produce various plants and vegetables for appreciating and eating. However, due to increasing environmental consciousness and care of health, people try all their best to avoid using insecticide, thus, organic vegetables marked of hygiene, environmental protection, noninsecticide, poisonless and residual of chemical composition are becoming the most popular and rapidly developing vegetables to the consumer in the 21th century. Refined agriculture is popular because that everyone can eat fresh vegetables grown by himself, nevertheless, although refined agriculture can avoid insecticide pollution, it requires loosing earth, fertilizing and so forth, and in particular, it is difficult for a beginner to effectively control appropriate timing of fertilizing and the quantity of fertilizer which directly relates to plants growing; The reason described above makes plants growing not to be completely and effectively controlled, and causes to unstable growth period, therefore, people can't enjoy fresh vegetables anytime.

### SUMMARY OF THE INVENTION

An object of the invention is to provide a plants growing device relating to various requirement of consumer and farmers to develop different products, consumer and farmers can selectively use the plants growing device to increase the quantity of output according to the requirement of consumer and farmers.

Another object of the invention is to provide a plants growing device especially for industry promotion and cost reduction, the plants growing device provides a time-saving and convenient manner for growing plants.

Another object of the invention is to provide a plants growing device, people conventionally use only herbicide to kill the weeds, however, herbicide severely pollutes nature and environment people live therein, the present invention uses a seed fixing film to prevent weeds from growing. The seed fixing film is composed of weaveless cloth, paper or various artifiaial material, and determined whether or not to add several holes on said seed fixing film according to various material.

Another object of the invention is to provide a plants growing device implemented to pot plants and outdoors grow plants in wide areas such that size of the growing area is changeable.

The plants growing device having advantages described above comprises: a seed fixing film added an upper thin film or gel thereon according to requirement; equidistantly dispose one or more plant seeds on the seed fixing film, cover a thin film or gel on the seed fixing film along with environmental requirement and requirement of growing plants, in order to fix the seeds and turn into a single layer type, and the device described above can be banded as a reel or be folded as computer form paper for saving space, thereby, the device is implemented according to the size of growing area and is not confined to space.

### BRIEF DESCRIPTION OF THE DRAWINGS

The drawings disclose an illustrative embodiment of the present invention which serves to exemplify the various advantages and objects hereof, and are as follows:

FIG. 1 is a schematic view of the first growing area of plants growing device according to the invention;

FIG. 2 is a schematic view of the second growing area of plants growing device according to the invention;

FIG. 3 is a schematic view of the third growing area of plants growing device according to the invention;

FIG. 4 is a schematic view of the fourth growing area of plants growing device according to the invention;

FIG. 5 is a schematic view of the fifth growing area of plants growing device according to the invention;

FIG. 6 is a schematic view of the sixth growing area of plants growing device according to the invention;

FIG. 7 is a schematic view of the seventh growing area of plants growing device according to the invention;

FIG. 8 is a schematic view of the eighth growing area of plants growing device according to the invention;

FIG. 9 is a schematic view of the ninth growing area of plants growing device according to the invention;

FIG. 10 is a schematic view of the tenth growing area of plants growing device according to the invention;

FIG. 11 is a schematic view of net setting of plants growing device according to the invention;

FIG. 12A is a schematic view of the plants growing device according to the invention to be bound for storing;

FIG. 12B is a schematic view of the plants growing device according to the invention to be folded as computer form paper;

FIG. 13A is a schematic view of plants growing device according to the invention implemented in large farm;

FIG. 13B is a schematic view of plants growing device according to the invention implemented in a pot;

FIG. 14 is a schematic view of exemplary embodiment of plants growing device according to the invention;

### DETAILED DESCRIPTION OF THE PREFERRED EMBODIMENT

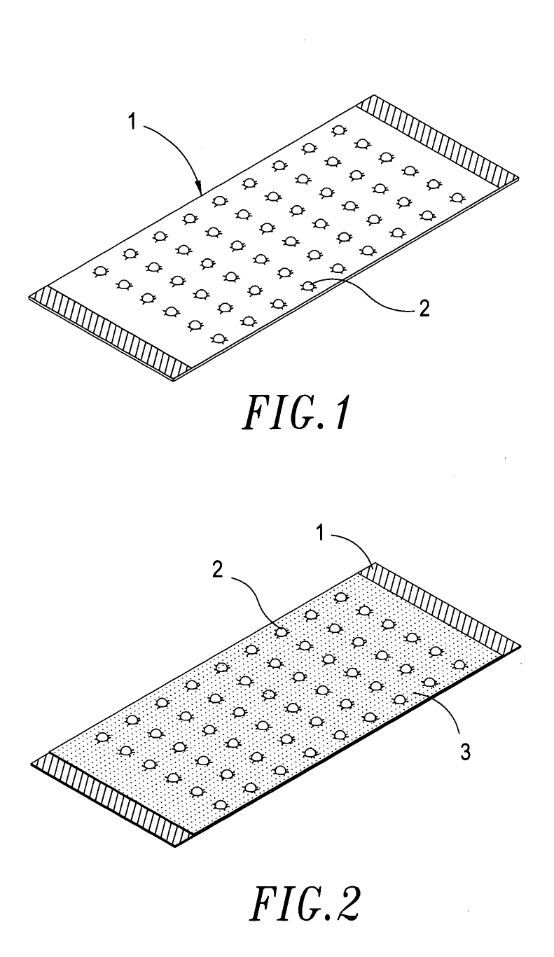

Referring to FIG. 1, a schematic view shows a plants growing device according to the invention, comprises:
a seed fixing film 1, said seed fixing film 1 is a dissolvable type or an undissolvable type in accordance with various material, if said seed fixing film 1 is an undissolvable type, it also has a function of grass anti-growing; besides, during the manufacture process of said seed fixing film 1, the raw material of said seed film is added seed preservative, nutrient, fertilizer, insecticide, germs or various special additive according to varied requirement and function;
a seed 2, directly reserving a growing space for the seed 2 when the material of said seed fixing film 1 is formed and is not dry yet, one or more seeds are equidistantly disposed on said seed fixing film 1 that is not dry, the seed 2 are fixed after said seed fixing film 1 dry.

Referring to FIG. 2, a schematic view shows another fixing manner of the seed, said seed fixing film 1 is dissolvable and spread with a thick gel layer 3, one or more seeds 2 are equidistantly disposed on said seed fixing film 1 when said gel layer 3 is not dry, making the seeds 2 sink into and close to said seed fixing film 1, the seeds 2 are fixed after said gel layer 3 dry, and spreading thick gel 3 around the seeds 2 for extending dissolved time of said gel film 3 to achieve a function of grass anti-growing.

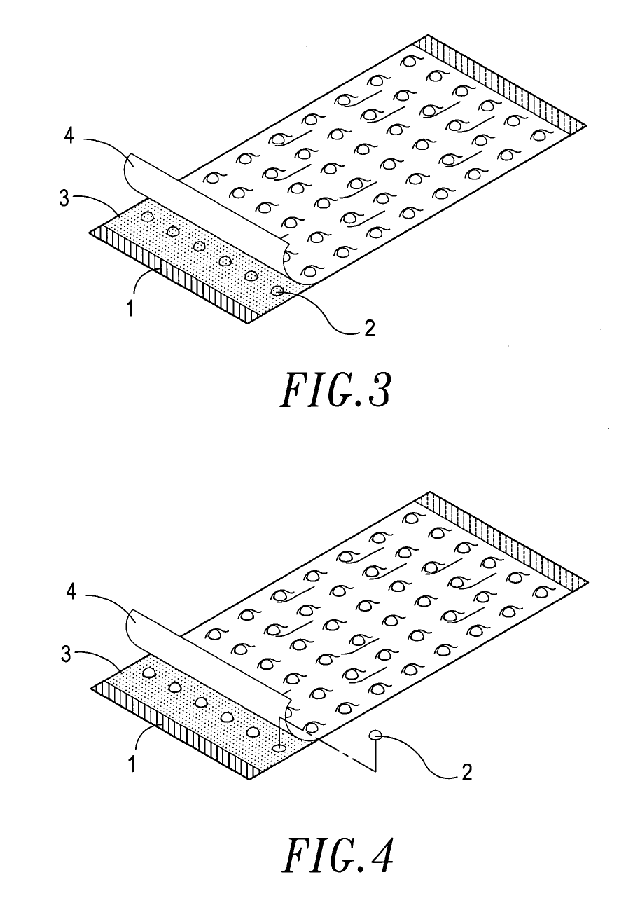

Referring to FIG. 3, the user can spread a thin gel layer 3 on said seed fixing film 1, one or more seeds 2 are disposed of fixed amount and position on said seed fixing film 1 and then covered with a thin gel layer 4, locating the seeds 2 between said seed fixing film 1 and said thin gel layer 4.

Referring to FIG. 4, reserving some placing space 11 on said seed fixing film 1 for the seed 2, spreading a gel layer 3 on the other position, when the seed 2 is placed in said placing space 11, a thin film layer 4 covered thereon, the steps described above make the seeds 2 covered with said seed fixing film 1 and said thin film 4.

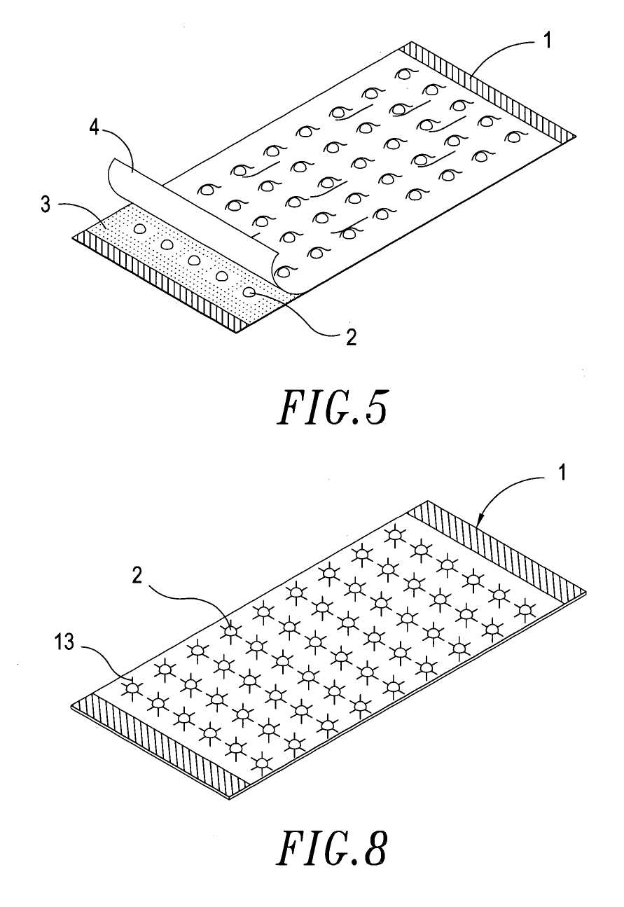

Referring to FIG. 5, the surface of said seed fixing film 1 is spread with a grid-like gel 3, the seeds 2 are disposed in said grid-like gel 3 and a thin film layer 4 covered thereon, the steps described above make the seeds 2 covered with and growable between said seed fixing film 1 and said thin film 4.

Referring to FIG. 6, the surface of said seed fixing film 1 is spread with a annular gel 3, the seeds 2 are disposed in said annular gel 3 and a thin film layer 4 covered thereon, the steps described above make the seeds 2 covered with and growable between said seed fixing film 1 and said thin film 4.

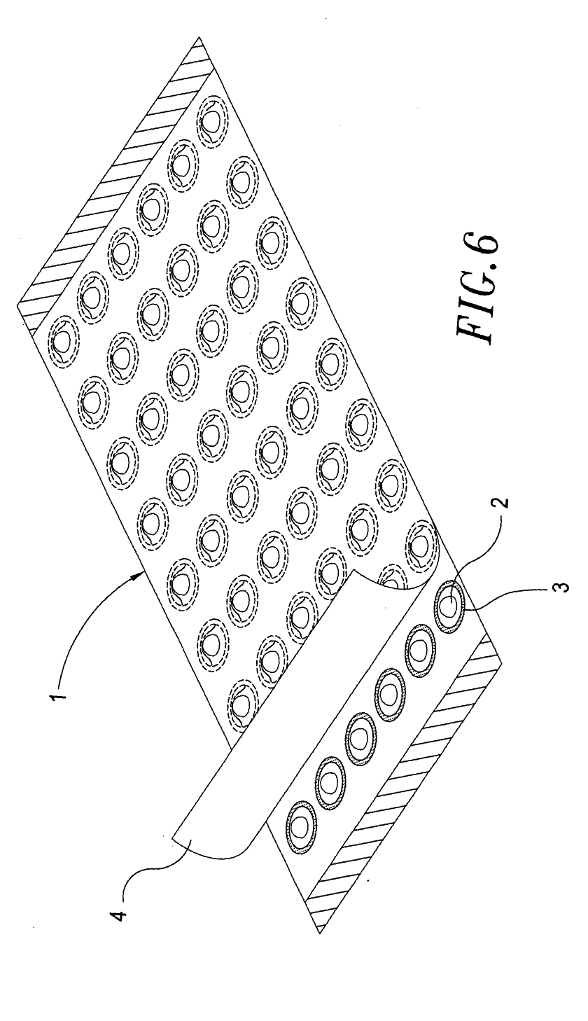

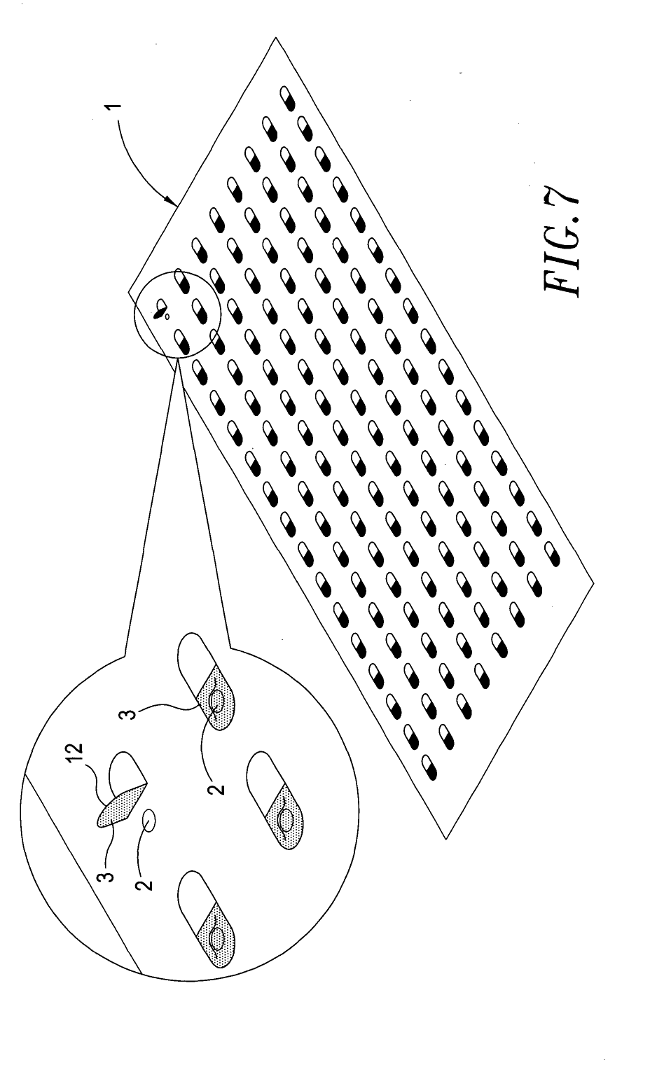

Referring to FIG. 7, cutting said seed fixing film 1 into several segment film 12 in the shape of a semicircle or a square or other geometric figures, the film 12 is spread with a gel layer 3, putting the seeds 2 on said film 12, then the film 12 is reversed and stuck to the surface of said seed fixing film 1, and then the seeds 2 are fixed in said film 12.

The gel layer 3 spread on said seed fixing film 1 is added seed preservative, nutrient, fertilizer, insecticide, germs or various special additive according to varied requirement and function. Additionally, said gel layer 3 can combine the additive comprises function of promoting plants growing and grass anti-growing.

Referring to FIG. 8, if said seed fixing film 1 is undissolvable, the user can cut several scars 13 in the type of a cross, a star or the other shape and disposing the seeds 2 on the scars 13, when the seeds 2 sprout, they strike root downward through said scars 13.

Referring to FIG. 9, if said seed fixing film 1 comprises a function of grass anti-growing, the user can dispose one or more holes 14 on said seed fixing film 1, wherein the hole 14 size is bigger than seed 2 size, one end of the hole 14 is covered with a thin film 4 for closing the hole 14, covering the other end of the hole 14 with a thin film 4 after the seed 2 is put into said hole 14 from the other end of the hole 14 for fixing the seed 2 in said hole 14, when the seeds 2 sprout, they strike root downward through said thin film 4.

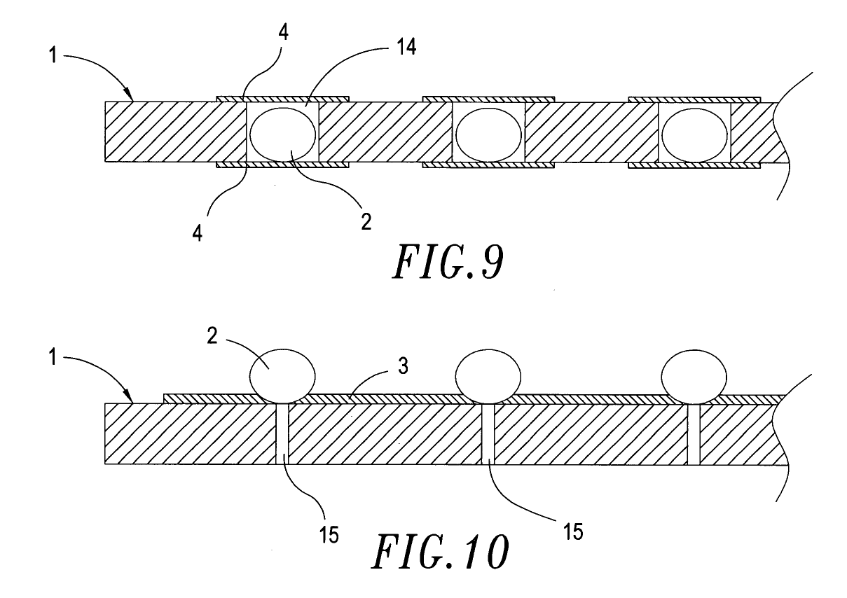

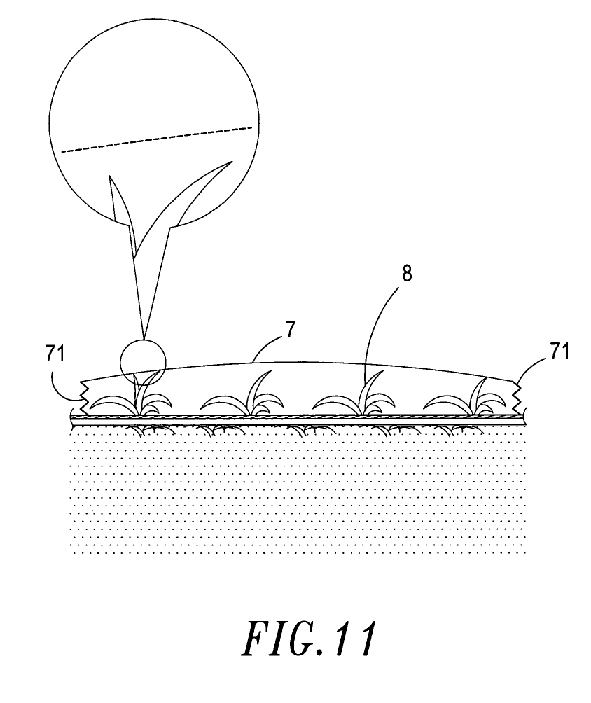

Referring to FIG. 10, if said seed fixing film 1 comprises a function of grass anti-growing, disposing one or more small holes 15 on said seed fixing film 1, wherein the hole 15 size is smaller than seed 2 size, then disposing the seed 2 in the small hole 15, said seeds 2 are fixed by gel 3 or covering with thin film, when the seeds 2 sprout, they strike root downward through said small holes 15.

Further, said seed fixing film 1 and said gel layer 3 is added seed preservative, nutrient, fertilizer, insecticide, germs or various special additive according to the requirement, or the above-described additive are directly disposed on or around the seeds 2, or blended with the seeds 2 for providing required nutrition of growth to the seeds 2, and said seed fixing film 1 is composed of weaveless cloth, paper or various artifiaial material, determined whether or not to add several holes on said seed fixing film 1 according to various material for helping plants growing and becoming a grass anti-growing film for preventing grass from growing.

In addition, said seed fixing film 1 is also configured with a net film layer 7 to prevent plants growing from insects, because imago does most damage to the plants, like laying eggs by butterfly, snails, spiral shells, and birds do lots harm to crops, it is a big work of plants growing to keep the plants from pests.

Referring to FIG. 11, the net film layer 7 is light and thin, the growing plants can easily prop up said net film layer 7 for not confining growth of the plants, elastic parts 71 are located on the two ends of said net film layer 7 for providing space needed for plants growing, the growing plants can easily prop up said net film layer 7 for not confining growth of the plants, furthermore, said net film layer 7 is pervious to water and light, rain-resistant, wind-resistant or the like, said net film layer 7 also prevents birds and above-described insects from invading and destroying the plants.

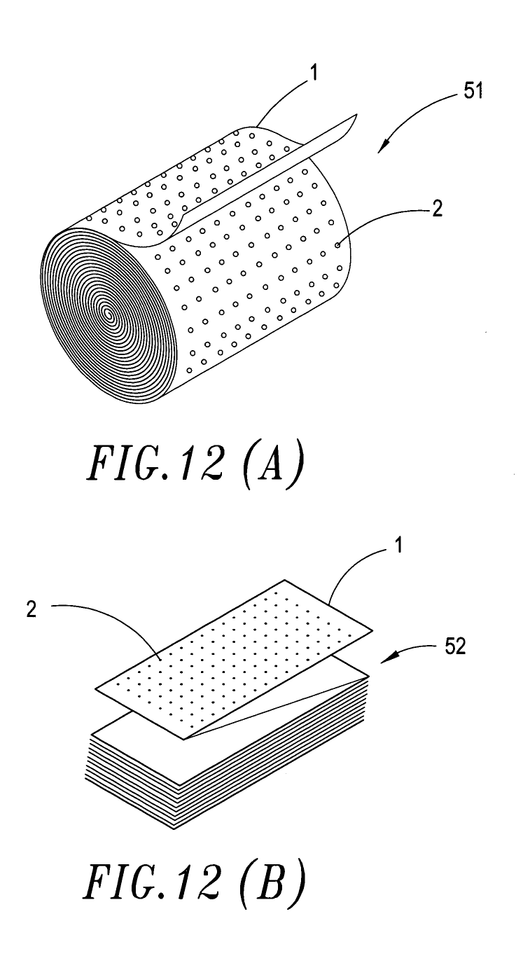

Referring to FIGS. 12A, 12B, in any case of using manners described above, or whether adding a net film layer 7, said seed fixing film 1 is pressed to form a band so as to be bound as a roll 51 for storing or be folded as computer form paper 52 for saving the space, and said seed fixing film 1 can be used according to practical growing area, settling essential land problem of plants growing.

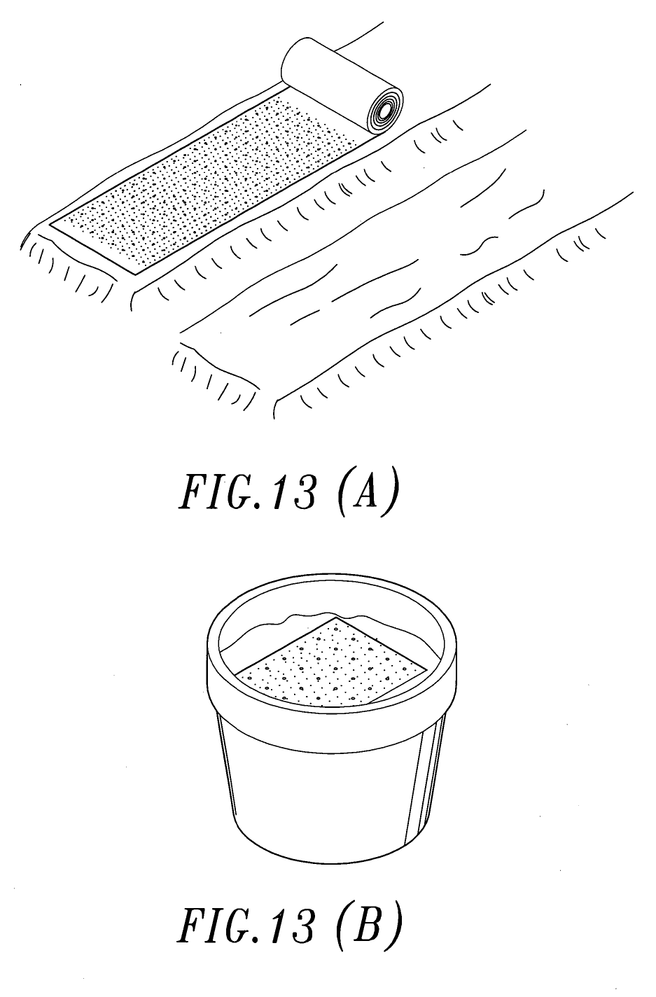

The application of the invention depends on requirement of grower, appropriate land, size of growing area and so forth. Referring to FIG. 13A, a schematic view shows applying the invention which is bound as a roll to a wide farmland, it's convenient to use the invention and the speed of seeding is faster than conventional way; Referring to FIG. 13B, the invention can be cut into suitable shapes and sizes according to the size of the growing pot, the user can do it by himself and cultivate his mind.

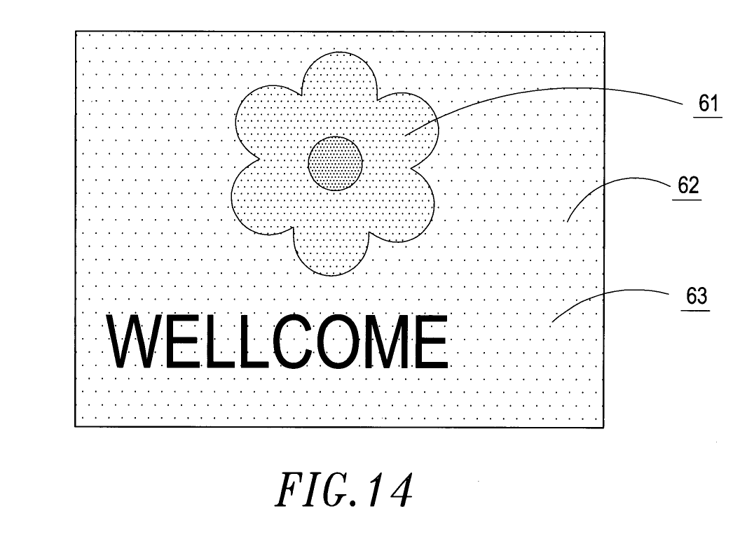

The invention provides a simple function of beautifying environment. Seed fixing film 1 is easily to be cut, therefore the user grows various flower seeds on the seed fixing film 1, the seeds are separated by strains and colors and formed a beautiful drawing, because that seed fixing film 1 grows no grass, it seems more colorful. Referring to FIG. 14, the user cuts different plant seeds into shapes or characters depends on what he needs, pattern 61 uses red flower seed, background 62 uses green plant seed, character 63 uses yellow flower seed, and all the seeds are arranged in order to be an easily cut and conveniently made gardening works, it is expectant to see the seeds growing into flowers or plants then become a beautiful work.

When comparing to above-described citation and prior art, the plants growing device provided by the invention has advantages:
1. The invention is to provide a plants growing device relating to various requirement of consumer and farmers to develop different products, consumer and farmers can selectively use the plants growing device to increase the quantity of output according to the requirement of consumer and farmers, especially for industry promotion and cost reduction.
2. The invention covers the seeds with a thin film that is added seed preservative, nutrient, fertilizer, insecticide, germs or various special additive, directly providing required nutrition of growth to the seed, canceling the complicated step of fertilizing and simplifying the process of growing, therefore, the invention is progressive.
3. The invention can simplify the process of plants growing, the user just needs to respectively apply the invention to growing medium or the surface of land, and the invention is not confined to space and can also make a big crop.
4. The seed fixing film of the invention is a dissolvable type or an undissolvable type in accordance with various material, farmers or users can apply the film to various growing lands, thus, the invention comprises various embodiment.

Many changes and modifications in the above-described embodiment of the invention can, of course, be carried out without departing from the scope thereof.

Accordingly, to promote the progress in science and the useful arts, the invention is disclosed and is intended to be limited only by the scope of the appended claims.

1. A plant growing device for growing plants, comprising:
a seed fixing film, said seed fixing film being formed of a dissolvable material adapted for blocking growth of grass, said fixing film material having at least one of a seed preservative, insecticide, and bacteria added thereto;
a plurality of seeds equidistantly disposed on said seed fixing film.

2-20. (Cancelled).
